(19) United States
(12) Patent Application Publication
(10) Pub. No.: US 2010/0296685 A1
(43) Pub. Date: Nov. 25, 2010

(54) ADAPTER AND ELECTRONIC DEVICES FOR RECESSED LIGHT SOCKET

(75) Inventors: William A. Carle, JR., Saint Joseph, MI (US); Edward Darrell Jervey, III, Richmond, VA (US); Steven Charles Machiorlette, Houston, TX (US)

Correspondence Address: BARNES & THORNBURG LLP, 600 ONE SUMMIT SQUARE, FORT WAYNE, IN, 46802, US

(73) Assignee: LAKE SHORE STUDIOS, INC., Saint Joseph, MI (US)

(21) Appl. No.: 12/783,981

(22) Filed: May 20, 2010

Related U.S. Application Data
(60) Provisional application No. 61/179,776, filed on May 20, 2009.

(51) Int. Cl. H04R 1/02; H01R 33/00; B23P 17/04

(52) U.S. Cl. 381/386; 439/641; 29/401.1

(57) ABSTRACT

An adaptive use of recessed lights cans for retrofitting various types of light fixtures. For example, a recessed light could be retrofitted as a junction box. In other embodiments, the recessed light could supply power for a speaker that includes a threaded power. Other electronic devices are contemplated that could be installed in a recessed light housing, including a battery backup light, a wireless repeater, a surveillance camera, a cellular phone booster, an infrared repeater, a fan, a wireless perimeter barrier, an alarm system, a sound machine, a web cam, an electronic pest control, a smoke detector, a carbon monoxide detector, an air purifier, a HVAC repeater control, a temperature monitor, a humidity monitor, a sound monitor, a photoelectric motion detector light, a photoelectric light sensor, and a hanging mobile.

### RELATED APPLICATION

This application claims the benefit of U.S. Provisional Application No. 61/179,776 filed on May 20, 2009, the entire disclosure of which is hereby incorporated by reference.

### TECHNICAL FIELD

This invention relates generally to an adaptive use of recessed lights cans for retrofitting various types of light fixtures. This invention also relates to electronic devices that can be installed in a recessed light socket.

### BACKGROUND

Recessed light fixtures are in wide-spread use. Typically, they are installed in a ceiling and direct light downward to the floor. Although recessed lights are suitable as a light source, other uses for recessed light housing are needed to provide more flexible locations for other electronic devices.

### SUMMARY

According to one aspect, the invention provides an adapter assembly for converting a recessed ceiling light socket into a junction box for installing a light fixture. The adapter assembly may include an adapter portion including a threaded portion that is configured to be screwed into a female light socket and a terminal block adapted to be in electrical communication with the threaded portion. A bracket may be provided that includes a first end operatively connected with the adapter portion and a second end extending from the adapter portion. In some cases, the second end includes a hole with internal threads configured to receive corresponding threads of a mounting device for a light fixture. The terminal block may include a first terminal and a second terminal for electrically connecting the light fixture to the light socket.

According to another aspect, the invention provides a method for converting a recessed ceiling light socket into a junction box for installing a light fixture. An adapter assembly may be provided that includes a threaded portion that is in electrical communication with a terminal block having a plurality of terminals. Wires of the light fixture are inserted into respective terminals of the terminal block and locked to establish an electrical connection between the light fixture and the terminals. The threaded portion of the adapter assembly is screwed into a socket of a recessed light to provide electrical power to the terminals.

According to a further aspect, the invention provides a speaker assembly adapted to be installed in a recessed light socket. The speaker assembly may include a threaded portion that is configured to be screwed into a female light socket. A circuit may be provided that is adapted to be in electrical communication with the threaded portion so that the threaded portion supplies electrical energy to power the circuit. A speaker is operatively associated with the adapter portion and in electrical connection with the circuit. The circuit includes an amplifier that is configured to drive the speaker with an input signal.

According to still another aspect, the invention provides an adapter assembly for powering an electronic device to be installed in a recessed light socket. The assembly may include a threaded portion that is configured to be screwed into a female light socket. An electrical device is provides that is adapted to be in electrical communication with the threaded portion so that the threaded portion supplies electrical energy to power the electrical device. The electronic device could be, for example, a battery backup light, a wireless repeater, a surveillance camera, a cellular phone booster, an infrared repeater, a fan, a wireless perimeter barrier, an alarm system, a sound machine, a web cam, an electronic pest control, a smoke detector, a carbon monoxide detector, an air purifier, a HVAC repeater control, a temperature monitor, a humidity monitor, a sound monitor, a photoelectric motion detector light, a photoelectric light sensor, and/or a hanging mobile.

Additional features and advantages of the invention will become apparent to those skilled in the art upon consideration of the following detailed descriptions exemplifying the best mode of carrying out the invention as presently perceived.

### BRIEF DESCRIPTION OF THE DRAWINGS

The present disclosure will be described hereafter with reference to the attached drawings which are given as non-limiting examples only, in which:

FIG. 1 is a perspective view of an example adapter assembly that may be installed in a recessed light socket for retrofitting a variety of light fixtures according to an embodiment of the invention;

FIG. 2 is a front view of the example adapter assembly shown in FIG. 1;

FIG. 3 is a left side view of the example adapter assembly shown in FIG. 1;

FIG. 4 is a bottom view of the example adapter assembly shown in FIG. 1;

FIG. 5 is a diagram showing example views and example dimensions for the adapter assembly shown in FIG. 1;

FIG. 6 is an exploded view showing an example adapter assembly for that is used for mounting a pipe hung light fixture;

FIG. 7 is a detailed view showing a portion of the adapter assembly of FIG. 6;

FIG. 8 is a side cross-sectional view of the adapter assembly of FIG. 6 in an assembled state;

FIG. 9 is an exploded view showing an example adapter assembly for that is used for mounting a cord hung light fixture;

FIG. 10 is a detailed view showing a portion of the adapter assembly of FIG. 9;

FIG. 11 is a side cross-sectional view of the adapter assembly of FIG. 9 in an assembled state;

FIG. 12 is an exploded view showing an example adapter assembly for that is used for mounting a low voltage light fixture;

FIG. 13 is a detailed view showing a portion of the adapter assembly of FIG. 12;

FIG. 14 is a side cross-sectional view of the adapter assembly of FIG. 12 in an assembled state;

FIG. 15 is a diagrammatical view of an example electronic device according to an embodiment of the invention; and

FIG. 16 is a diagrammatical view of an example speaker assembly according to an embodiment of the present invention.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

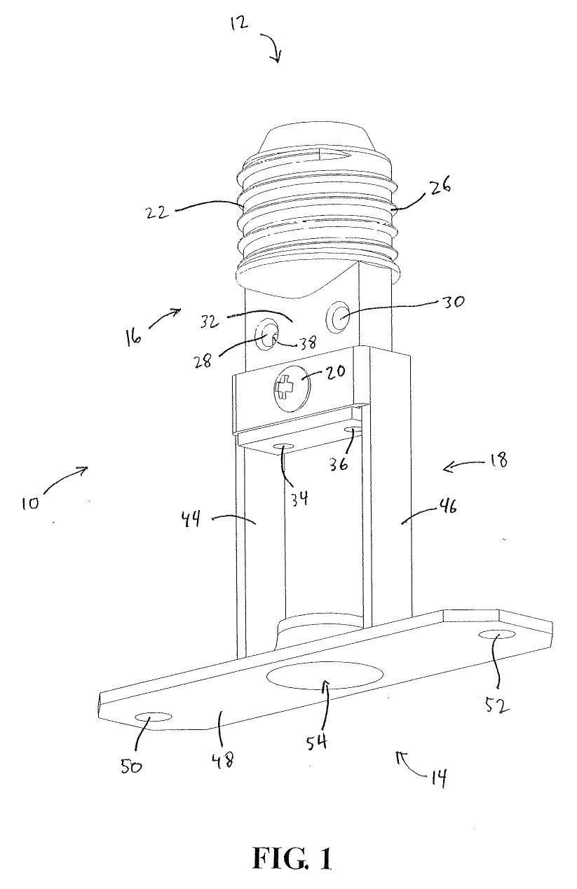

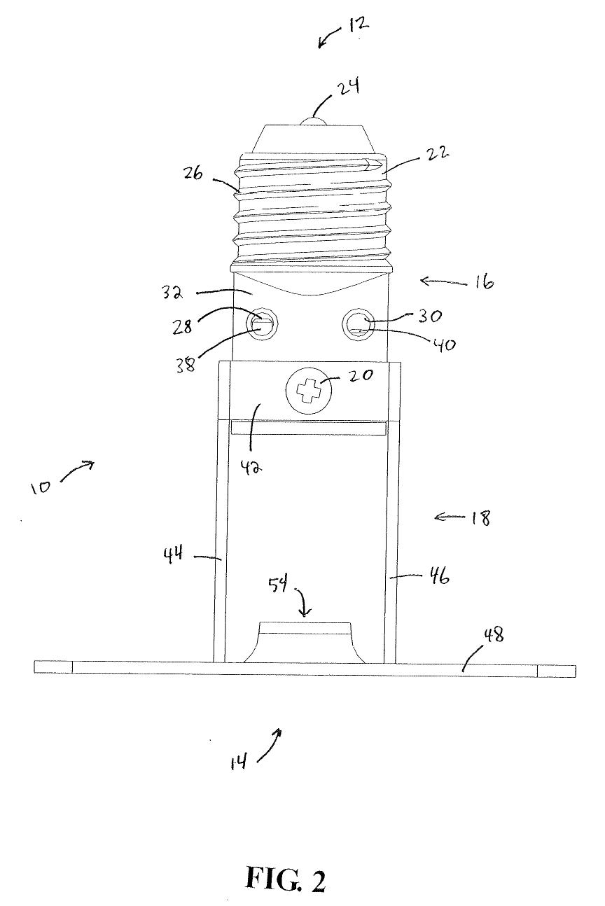

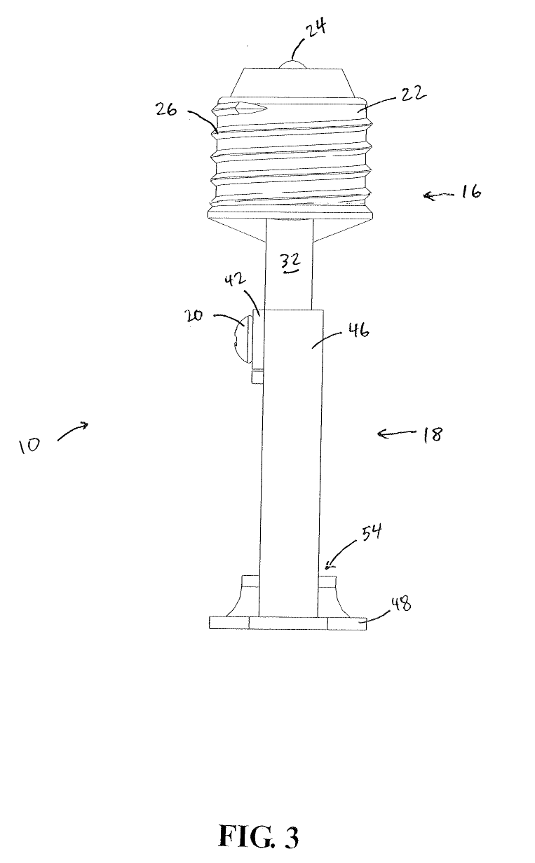

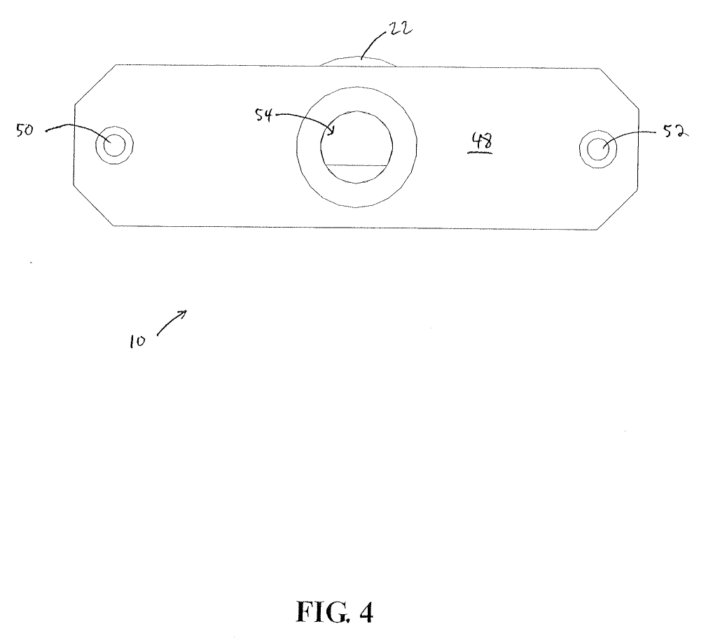

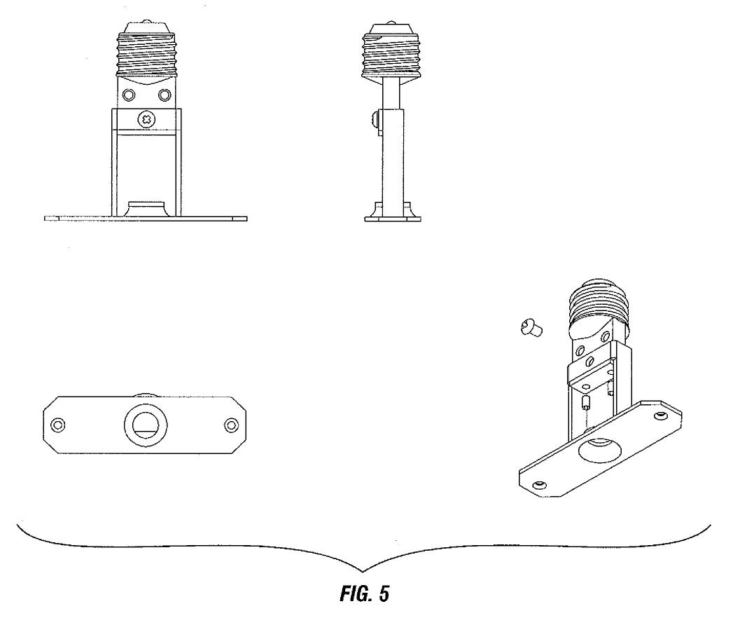

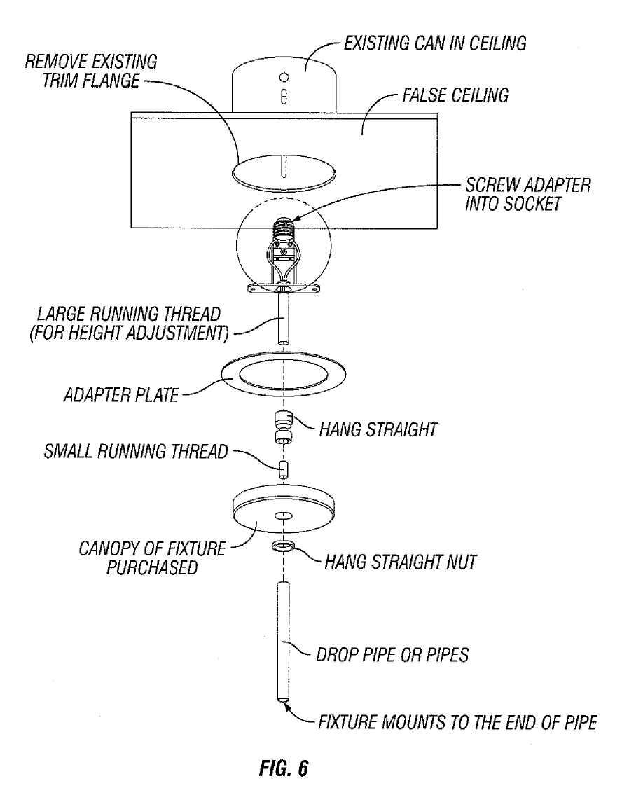

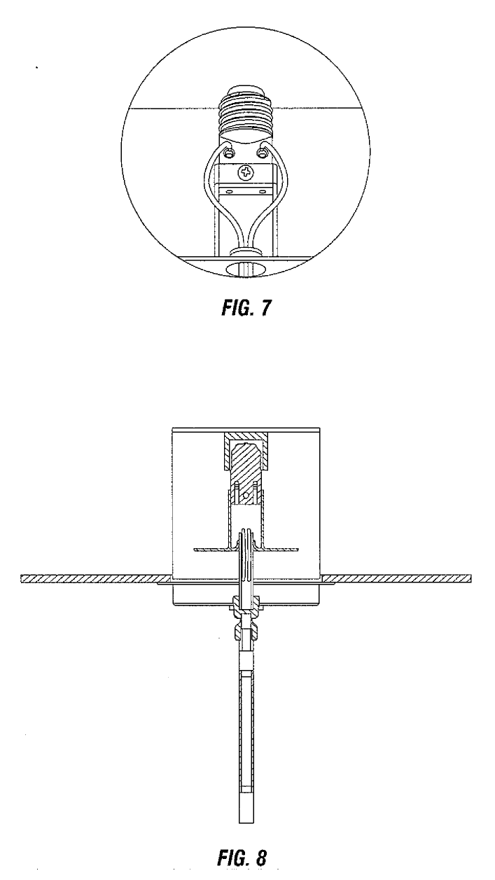

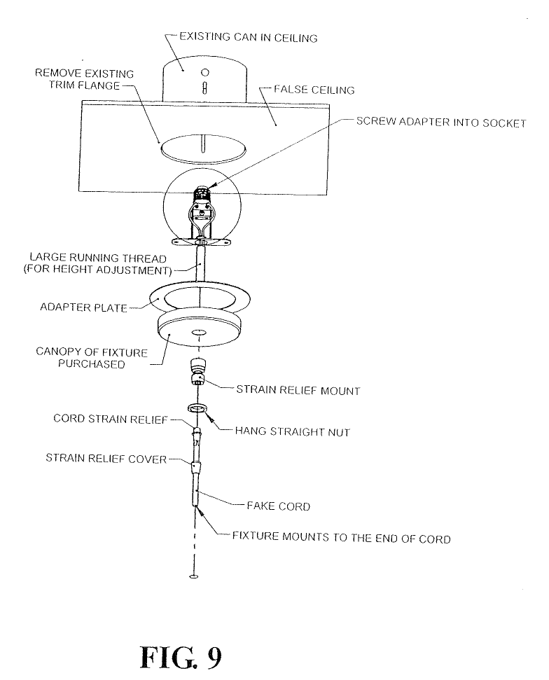

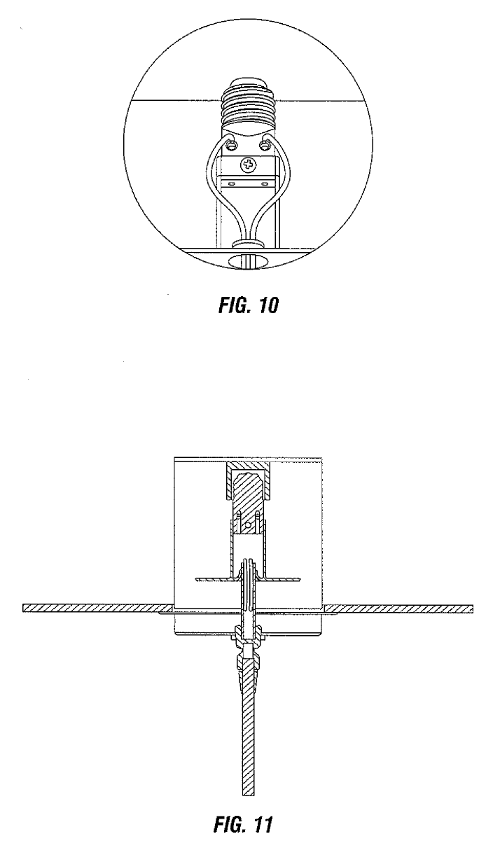

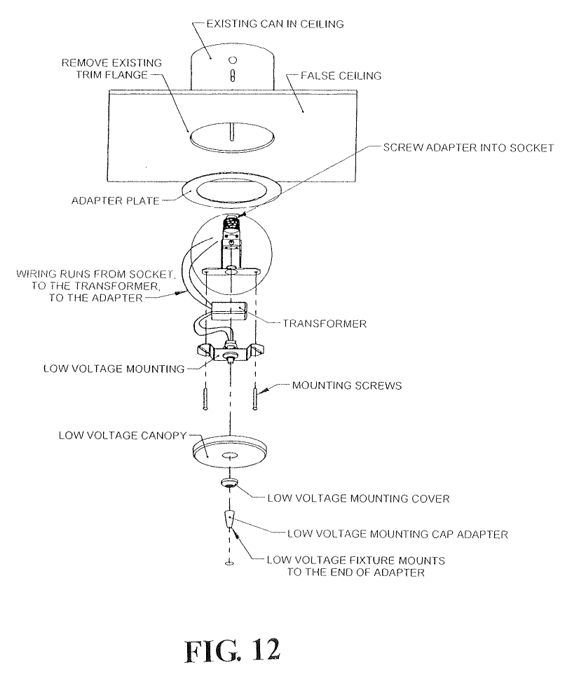

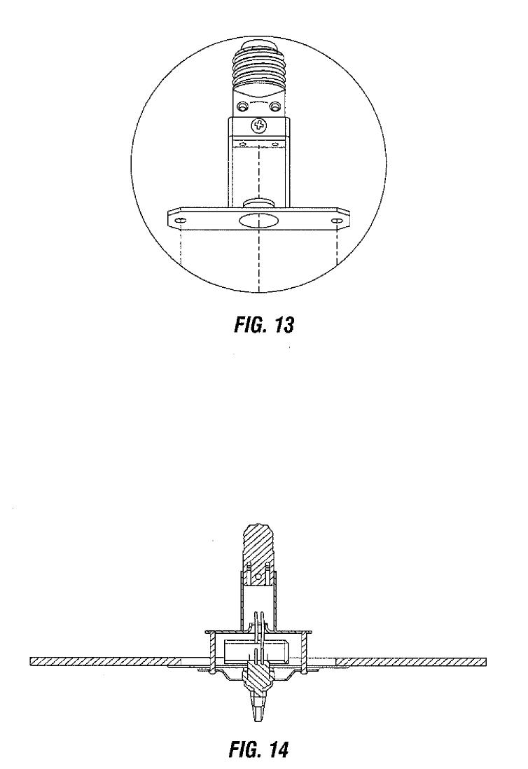

In one embodiment, the present invention provides an adapter that can be used to transform a recessed can light into a junction box that allows any kind of light fixture to be installed, including but not limited to pipe hung fixtures, cord hung fixtures and low voltage fixtures. Moreover, the adapter allows for light fixtures to be installed with any style of light bulb, including but not limited to incandescent, compact fluorescent, LED and low voltage bulbs. An embodiment of the adapter is shown in FIGS. 1-5; however, the adapter in FIGS. 1-5 is shown for example purposes only and is not intended to be limiting on the invention. FIGS. 6-14 illustrate an example arrangement for installing a variety of lighting fixtures with the adaptor.

In another aspect, the invention provides an electronic device that can be installed in to a recessed light socket. In some cases, the adapter may include or be associated with a LED light source; in such embodiments, the relatively small, low-heat emitting LED bulbs would allow extra space in existing light fixtures created by these smaller bulbs to be utilized for additional or alternative functions. As discussed below, embodiments are also contemplated in which the electronic device could be, but is not limited to, a speaker, a wireless (e.g., Bluetooth) adapter, battery backup lighting, wireless (e.g., WiFi) repeater, surveillance camera, cellular phone booster, infrared repeater, fan, wireless perimeter barrier (e.g., wireless barrier for pets), alarm system, sound machine, web cam, electronic pest control, smoke detector, carbon monoxide detector, air purifier, HVAC repeater control, temperature monitor, humidity monitor, sound monitor, photoelectric motion detector light, photoelectric light sensor, and/or hanging mobile. In some embodiments, the adapter could be pre-attached/pre-assembled to a light source, plus another electronic device, such as a smoke detector, speaker, wi-fi repeater, etc. For example, the adapter could be donut-shaped in some cases with a LED light bulb in the center.

FIGS. 1-5 show an example embodiment of an adapter assembly 10 for transforming a recessed can light into a junction box that allows any kind of light fixture to be installed. As shown, the adapter assembly 10 has an upper end 12 and a lower end 14. In the embodiment shown, the upper end 12 includes an adapter portion 16 that is coupled with a bracket 18 using a fastener 20. Although the fastener 20 is shown as a screw for purposes of example, one skilled in the art should recognize that other types of fasteners could be used, including but not limited a bolt/nut, frictional fit, interference fit and/or adhesive.

As shown, the adapter portion 16 includes a threaded portion 22 that is adapted to be screwed into a female light socket within a recessed light. The socket, of course, is electrically connected to power within the building so that when a light bulb is screwed into the socket, power is supplied to the bulb. Although the adapter portion 16 is shown with the threaded portion 22 for purposes of example, other embodiments are contemplated in which the adapter portion 16 could be configured to connect with other types of light sockets, such as a bayonet-type light socket or other types of sockets.

The adapter portion 16 includes electrical connectors 24, 26 (on the threaded portion in the embodiment shown) that provide an electrical connection with the socket when the adapter portion 16 is screwed into the socket. The electrical connectors 24, 26 provide electrical communication with respective terminals 28, 30 of a terminal block 32. Although the example terminal block 32 shows two terminals for purposes of example, the terminal block could include multiple additional terminals as desired. Embodiments are contemplated in which terminals could be provided that output a processed signal. For example, the terminal block could include terminals that output an AC signal and other terminals that output a DC signal. One skilled in the art should appreciate that the input power signal could be processing in other manners. Although the embodiment shown has terminals 28, 30 on the front of the terminal block 32, the terminals 28, 30 could be oriented on the side or other locations on the terminal block 32.

In the example shown, the terminal block 32 includes openings 34, 36 that are internally threaded to receive respective set screws 38, 40 for locking wire into position in the terminals 28, 30. The set screws 38, 40 are shown for purposes of example, but other mechanisms could be used to lock wires into the terminals 28, 30.

The bracket 18 has an upper portion with a cross member 42 that is disposed between legs 44, 46. The legs 44, 46 are spaced apart a distance approximately equal to the width of the adapter portion 16 to prevent lateral movement of the adapter portion 16. In this embodiment, the cross member 42 includes a hole through which the fastener 20 extends. The opposing ends of the legs 44, 46 are coupled with a strap portion 48. As shown, the strap portion 48 includes holes 50, 52 through which fasteners can pass to install a light fixture. A central hole 54 is provided in the strap portion 48. Typically, the central hole 54 includes internal threads for receiving corresponding threads in a mounting device for installing the light fixture.

When installing the adapter assembly 10, the power to the socket is typically turned off for safety reasons and the conventional light bulb is removed from the socket. The wires for the light fixture to be installed are inserted through the central hole 54. The bare end of the wires (i.e., portion of wires stripped of installation) are inserted into the respective terminals 28, 30 of the terminal block 32. The set screws 38, 40 are screwed to lock the wires into the terminals 28, 30. The threaded portion 22 of the adapter portion 16 is then screwed into the socket to provide power to the terminals 28, 30. The FIGS. 6-14 show the mariner of installing a variety of light fixtures.

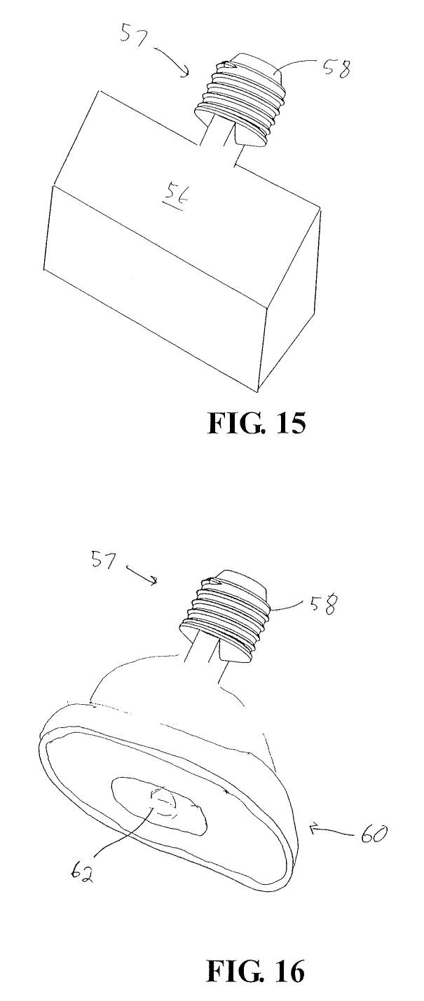

As discussed above, the invention also provides various electronic devices that can be installed in a recessed light socket. FIG. 15 shows a diagrammatic view of an example electronic device 56 with an adapter portion 57, which in this example has a threaded portion 58 that is adapted to be screwed into a female light socket within a recessed light. The socket, of course, is electrically connected to power within the building so that when a light bulb is screwed into the socket, power is supplied to the bulb. Accordingly, the threaded portion 58 could be adapted to provide an electrical power source for the electronic device 56. Other embodiments are contemplated in which the threaded portion 56 could be configured to connect with other types of light sockets, such as a bayonet-type light socket or other types of sockets.

In one embodiment, for example, the electronic device could be a speaker 60, such as the example speaker 60 shown in FIG. 16. In such an embodiment, the speaker 60 would include an adapter 57 with a threaded portion 58 that screws into the light socket of a can light to provide power for the speaker 60. In some cases, the speaker 60 may include an articulating portion to direct the sound to a desired location. Embodiments are contemplated in which the speaker may include circuitry for receiving and playing wireless transmissions. A radio, CD player, MP3 or other media player could be integrated with the speaker in some embodiments. In some embodiments, the speaker 60 may include processing circuitry to play a particular channel of a signal. For example, the speaker may be configured as a left/right channel for a stereo signal. By way of another example, the speaker could be configured to play as a left/center/right/rear/side speaker in a multichannel transmission, such as for a 5.1, 6.1 or 7.1 signal. In some cases, the speaker 60 may be adapted for an outdoor environment. Depending on the exigencies of the particular situation, the speaker 60 could include a light 62. As discussed below, the light 62 and a speaker amplifier could be independent switched. In other words, the speaker 60 could be configured to continue playing even if the light is switched off.

In another embodiment, the electronic device could be a wireless adapter, such as a Blue Tooth™ adapter for sending/receiving Blue Tooth™ communications. In such an embodiment, the wireless adapter would include an adapter portion for screwing into the light socket of a recessed can light. In some cases, the wireless adapter could be combined with other electronic devices, such as a speaker. For example, the speaker could be configured to play media from an MP3 player or cell phone configured with Blue Tooth communications. In some embodiments, the wireless adapter could include a light.

Embodiments are contemplated in which the electronic device is battery back up lighting. The back up lighting in case of power outage could be screwed into a recessed lighting fixture.

In another embodiment, the electronic device could be a wireless repeater or wireless bridge, such as WiFi, repeater or bridge. For example, in the case of a repeater, would include an adapter that screws into the light socket of a recess can light for power and repeats a wireless signal expand a wireless network. The wireless repeat may or may not include a light. As discussed, the light may be switched independently.

A further embodiment is contemplated in which the electronic device is a surveillance camera. In this embodiment, the surveillance camera would include an adapter portion that screws into recessed can light to power the camera. The camera may or may not include a light.

Embodiments are contemplated in which the electronic device could be a cell phone booster that increases signal strength of a cell phone. The cell phone booster would include an adaptor portion that provides electrical power to the booster when screwed into a recessed can light.

In another embodiment, the electronic device could be a remote and infrared (“IR”) repeater. The repeater would include an adapter portion screws into a recessed can light socket for power and could control any electronic device by repeating the signals through walls using IR technology. The repeater may or may not include a light.

In a further embodiment, the electronic device could be a fan. The fan would include an adapter portion that screws into recessed can light socket to supply electrical power. The fan could be an exhaust fan or down draft fan and may or may not include a light.

Embodiments are contemplated in which the electronic device could be a wireless dog fence. In such an embodiment, the device would include an adapter portion that screws into recessed can light socket and provides a perimeter barrier around the house to contain a dog on a property. The device may or may not include a light.

In some cases, the electronic device could be a component of an alarm system. The alarm system, including but not limited to infrared detectors, includes an adapter portion that screws into a recessed can light socket. The alarm system may or may not include a light. For example, the electronic device could be a siren.

In a further embodiment, the electronic device could be a sound machine. The sound machine would include an adapter portion that screws into recessed can light socket and could be controlled by a remote. The sound machine may or may not include a light.

Embodiments are contemplated in which the electronic device could be a camera or video camera. The camera would include an adapter portion that screws into a recessed can light socket and is run by WiFi (or other wireless protocol). The web cam may or may not include a light.

In another embodiment, the electronic device could be an electronic pest control. The pest control includes an adapter that screws into a recessed can light socket. The device may or may not include a light.

In a further embodiment, the electronic device could be a smoke and/or carbon monoxide detector. The detector would include an adapter portion that screws into recessed can light socket. In some cases, the detector could have battery back up. The detector may or may not have a light.

Embodiments are contemplated in which the electronic device could be an air purifier. The purifier would include an adapter portion that screws into recessed can light socket for electrical power. The purifier may or may not include a light.

In some embodiments, the electronic device may be an HVAC Repeater Control that allows control of a building's heat from any room. The controller would include an adapter portion that screws into a recessed can light socket. The controller may or may not include a light.

In a further embodiment, the electronic device may be a temperature and/or humidity monitor that monitors the environment around the device. In some cases, the monitor could transmit the measured information to another room or base station. The monitor would include an adapter portion that screws into a recessed can light socket. It may or may not include a light.

In another embodiment, the electronic device could be a sound monitor that allows listening to the surrounding space from any room where the device is screwed in to a recessed can. In some cases, the device may use wireless transmission to another room or base station. The monitor may or may not include a light.

In a further embodiment, the electronic device may be photoelectric motion detector lights and/or light sensors. For example, the device could monitor surrounding areas for motion and activate lighting in a single room or multiple areas. By way of another example, the device could monitor surrounding areas for light and decrease or increase light in levels of light activates in a single room or multiple areas. This type of device could be used as night lighting or other applications where automation of lighting is desirable.

In another embodiment, the electronic device could be a hanging mobile, similar to those that hang over a crib and rotate. This would allows a portable crib (pack-n-play) to be positioned anywhere there is a recessed can. The hanging mobile would include an adapter portion that screws into the recessed can light socket.

In many of the embodiments, the electronic devices will need an unswitched, or constant power source to be an integral part of the device. While other lights or devices are a part of the same electronic circuit and will utilize a common wall switch, the defined embodiment will employ an internal switching or receiving mechanism that will allow a constant power source to the device, while the other lights or devices may receive switched power from the common wall switch.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. An adapter assembly for converting a recessed ceiling light socket into a junction box for installing a light fixture, the adapter assembly comprising:
an adapter portion including a threaded portion that is configured to be screwed into a female light socket and a terminal block adapted to be in electrical communication with the threaded portion; and
a bracket including a first end operatively connected with the adapter portion and a second end extending from the adapter portion, wherein the second end includes a hole with internal threads configured to receive corresponding threads of a mounting device for a light fixture; and
wherein the terminal block includes a first terminal and a second terminal for electrically connecting the light fixture to the light socket.

2. The adapter assembly of claim 1, wherein the terminal block includes a plurality of terminals, and wherein the terminal block includes a plurality of openings that are internally threaded to receive respective set screws for locking wire into position in the terminals.

3. The adapter assembly of claim 1, wherein the bracket includes a cross member that is disposed with a first leg and a second leg.

4. The adapter assembly of claim 3, wherein the first leg and the second leg suspend the second end of the bracket apart from the adapter portion.

5. The adapter assembly of claim 4, wherein the hole is positioned between the first leg and the second leg.

6. The adapter assembly of claim 5, wherein the second end of the bracket includes a first mounting hole and a second mounting hole, wherein the hole is disposed between the first mounting hole and the second mounting hole.

7. The adapter assembly of claim 1, wherein the terminal block includes a plurality of terminals and at least one of the terminals includes circuitry for outputting a DC signal.

8. A method for converting a recessed ceiling light socket into a junction box for installing a light fixture, the method comprising the steps of:
providing an adapter assembly including a threaded portion that is in electrical communication with a terminal block having a plurality of terminals;
inserting wires of a light fixture into respective terminals of the terminal block;
locking the wires into the terminals to establish an electrical connection between the light fixture and the terminals;
screwing the threaded portion of the adapter assembly into a socket of a recessed light to provide electrical power to the terminals.

9. The method of claim 8, wherein the adapter assembly includes a strap portion with an internally threaded hole, further comprising the step of screwing a mounting assembly of the light fixture into the internally threaded hole of the strap portion.

10. The method of claim 8, wherein the locking step includes screwing a set screw into the terminals to lock the wire in the terminals.

11. A speaker assembly adapted to be installed in a recessed light socket, the speaker assembly comprising:
a threaded portion that is configured to be screwed into a female light socket;
a circuit adapted to be in electrical communication with the threaded portion;
wherein the threaded portion supplies electrical energy to power the circuit;
a speaker operatively associated with the adapter portion and in electrical connection with the circuit; and
wherein the circuit includes an amplifier that is configured to drive the speaker with an input signal.

12. The speaker assembly of claim 11, further comprising a light source for projecting light from the speaker.

13. The speaker assembly of claim 12, wherein the light source includes an LED bulb.

14. The speaker assembly of claim 12, wherein the circuit is configured to independently switch power to the light source and the amplifier.

15. The speaker assembly of claim 11, wherein the circuit is configured to wirelessly receive an input signal for driving the speaker.

16. An adapter assembly for powering an electronic device to be installed in a recessed light socket, the adapter assembly comprising:
a threaded portion that is configured to be screwed into a female light socket;
an electrical device adapted to be in electrical communication with the threaded portion, wherein the threaded portion supplies electrical energy to power the electrical device;
wherein the electronic device is one or more of a battery backup light, a wireless repeater, a surveillance camera, a cellular phone booster, an infrared repeater, a fan, a wireless perimeter barrier, an alarm system, a sound machine, a web cam, an electronic pest control, a smoke detector, a carbon monoxide detector, an air purifier, a HVAC repeater control, a temperature monitor, a humidity monitor, a sound monitor, a photoelectric motion detector light, a photoelectric light sensor, or a hanging mobile.
